(19) United States
(12) Patent Application Publication
(10) Pub. No.: US 2009/0145095 A1
(43) Pub. Date: Jun. 11, 2009

(54) Air filter cartridge and air cleaner

(75) Inventors: William Michael Juliar, Coon Rapids, MN (US); David Escher, Brooklyn Park, MN (US); Kevin J. Schrage, Spring Valley, MN (US)

Correspondence Address: MERCHANT & GOULD PC, P.O. BOX 2903, MINNEAPOLIS, MN, 55402-0903, US

(73) Assignee: DONALDSON COMPANY, INC., MINNEAPLIS, MN (US)

(21) Appl. No.: 11/988,616

(22) PCT Filed: Jul. 11, 2006
(86) PCT No.: PCT/US2006/027201

§ 371 Date: Feb. 2, 2009

Related U.S. Application Data
(60) Provisional application No. 60/699,136, filed on Jul. 13, 2005.
(60) Provisional application No. 60/726,907, filed on Oct. 14, 2005.

(51) Int. Cl. B01D 46/24

(52) U.S. Cl. 55/359; 55/476

(57) ABSTRACT

The disclosure concerns air cleaners (70) and replacement parts for air cleaners. A preferred replacement part air filter cartridge (1) is depicted which includes first and second ends, with filter media extending therebetween; and, a laterally outwardly flexible axial seal ring (22) on the first end, circumscribing an air flow exit aperture. Examples of preferred filter cartridges with preferred laterally flexible axial seal rings (22) thereon, are shown and described. Also described is an air cleaner (70) including the filter cartridge (1). Further, an air cleaner including an air aperture (105) in communication with a region between an axial seal ring (22) and a radially extending dust shield (45) is provided. Methods of assembly and use are described.

### CROSS REFERENCE TO RELATED APPLICATION

This application is being filed on 11 Jul. 2006, as a PCT International Patent application in the name of Donaldson Company, Inc., a U.S. national corporation, applicant for the designation of all countries except the US, and William Michael Juliar, David Escher, and Kevin Schrage, all citizens of the US, applicants for the designation of the US only.

The present application includes the disclosure of U.S. provisional application 60/726,907 filed Oct. 14, 2005. The entire disclosure of U.S. 60/726,907 is incorporated herein and a claim of priority to U.S. application 60/726,907 is made to the extent appropriate.

The present application also includes certain subject matter included in U.S. provisional application 60/699,136 filed Jul. 13, 2005. The complete disclosure of provisional application 60/699,136 is incorporated herein by reference. In addition, a claim of priority is made to U.S. provisional application 60/699,136, to the extent appropriate.

### FIELD OF THE DISCLOSURE

The present disclosure concerns air cleaners and parts thereof. It particularly concerns air cleaners having housings and removable and replaceable (i.e., serviceable) filter cartridges. The particular arrangements shown and described herein, involve serviceable filter cartridges with improved axial seal arrangements.

### BACKGROUND

Air filtering is used in a variety of arrangements. A typical application is as an air cleaner for intake air to internal combustion engines. After a period of use, filter media within the cleaner requires servicing, either through cleaning or complete replacement. Typically, for an air cleaner used with an internal combustion engine such as on a vehicle, filter media is contained in a removable or replaceable (i.e., serviceable) component, element or cartridge. Examples are shown in U.S. Provisional Application 60/421,882 filed Oct. 28, 2002; U.S. Provisional Application 60/453,737, filed Mar. 6, 2003; U.S. Utility application Ser. No. 10/691,856, filed Oct. 28, 2002, now published as US 2004/0134171 on Jul. 15, 2004; PCT Application US 03/33952, filed Oct. 28, 2002, now published as PCT WO 04/039476, on May 13, 2004; and, U.S. Provisional Application 60/699,136, filed Jul. 13, 2005.

Selected arrangements of each of the references described in the previous paragraph, involve creation of an axial seal as a housing seal, positioned, in use, between a filter cartridge and a housing. In this disclosure, improvements in formation of such axial seals are described.

### SUMMARY

The present disclosure concerns improvements in air cleaners. The techniques are particularly developed for use with air cleaners for cleaning engine air intake for an internal combustion engine, such as used with a vehicle such as a bus, truck or mobile equipment such as a tractor or construction equipment, or a stationary generator. The improvements generally relate to air cleaners in which filter media is part of a removable and replaceable (i.e., serviceable) component.

The present disclosure concerns improvements developed in connection with utilization of air cleaners in accord with the disclosure of US Publication 2004/0134171, published on Jul. 15, 2004; PCT Publication WO 04/039476, published on May 13, 2004; and, U.S. Provisional Application 60/699,136, filed Jul. 13, 2005, incorporated herein by reference. The techniques in part concern modifications in an axial seal of the filter cartridge, to accomplish certain desired effects. In addition, an optional improvement in the housing, described in U.S. provisional application 60/699,136 incorporated herein by reference, is provided.

Herein, some specific, advantageous, features are described and shown. It is not a requirement that an arrangement include all of the features described herein, to obtain some advantage.

### BRIEF DESCRIPTION OF THE DRAWINGS

FIG. 1 is a side elevational view of a filter cartridge including according to the present disclosure;

FIG. 2 is an end view of the cartridge of FIG. 1;

FIG. 3 is an enlarged cross-sectional view of the cartridge of FIG. 1, taken along line 3-3, FIG. 2;

FIG. 4 is an enlarged fragmentary view of a portion of FIG. 3;

FIG. 4A is a view of FIG. 4 with dimension lines, radii, and angles indicated.

FIG. 5 is an enlarged cross-sectional view depicting the filter cartridge of FIG. 1 mounted in an air cleaner assembly along with an internal support structure;

FIG. 6 is an enlarged fragmentary schematic view of a portion of FIG. 5;

FIG. 7 is a side elevational view of an alternate filter cartridge to the filter cartridge of FIG. 1;

FIG. 8 is an end elevational view of a closed end of the filter cartridge of FIG. 7;

FIG. 9 is an enlarged cross-sectional view taken along line 9-9, FIG. 8;

FIG. 10 is an enlarged fragmentary view of a portion of FIG. 9;

FIG. 10A is a view of FIG. 10 with dimension lines, radii and angles indicated.

FIG. 11 is a bottom plan view of an alternate air cleaner housing usable with a filter cartridge according to FIGS. 1-4 and also FIGS. 7-10;

FIG. 12 is a cross sectional view of the air cleaner depicted in FIG. 11, with a filter cartridge modified from those depicted in FIGS. 1-4 and FIGS. 7-10 positioned therein; and,

FIG. 13 is an enlarged fragmentary view of a portion of FIG. 12.

### DETAILED DESCRIPTION

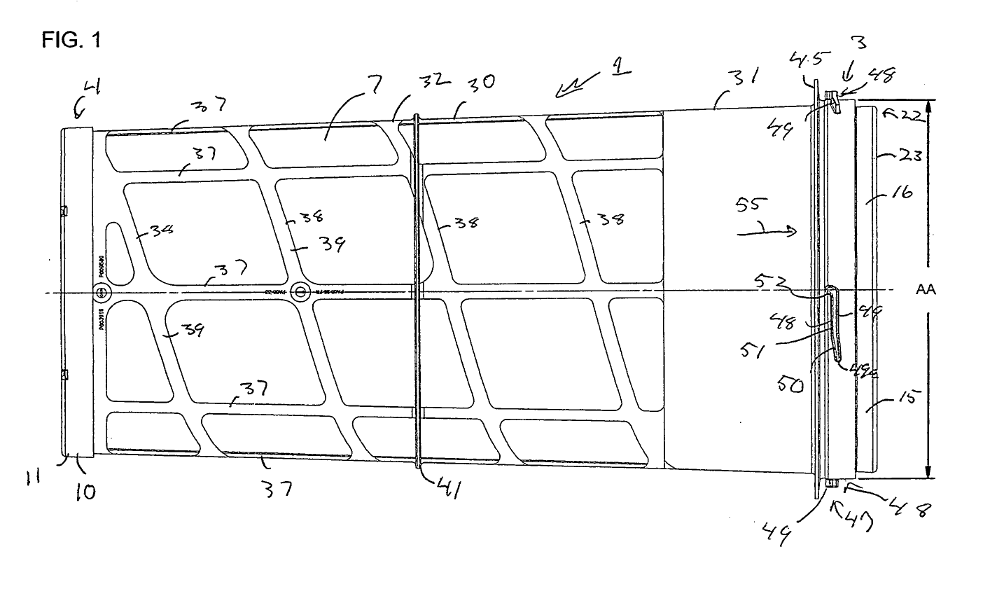

### I. An Example Filter Cartridge, FIGS. 1-6

As indicated previously, the present disclosure in part concerns improvements in filter cartridges of the general type described in US Publication US 2004/0134171, published on Jul. 15, 2004 and PCT Publication WO 04/039476, published on May 13, 2004, incorporated herein by reference. An example of such an improved filter cartridge is depicted in FIGS. 1-6.

Referring first to FIG. 1, the reference numeral 1 generally identifies such a filter cartridge. In general, the cartridge 1 includes first and second opposite ends 3 and 4, with filter media 7 extending therebetween. The media 7 may comprise any variety of media types, a typical example being pleated media. The specific media selection and configuration is a matter of design choice, based upon the specific needs for the air cleaner involved.

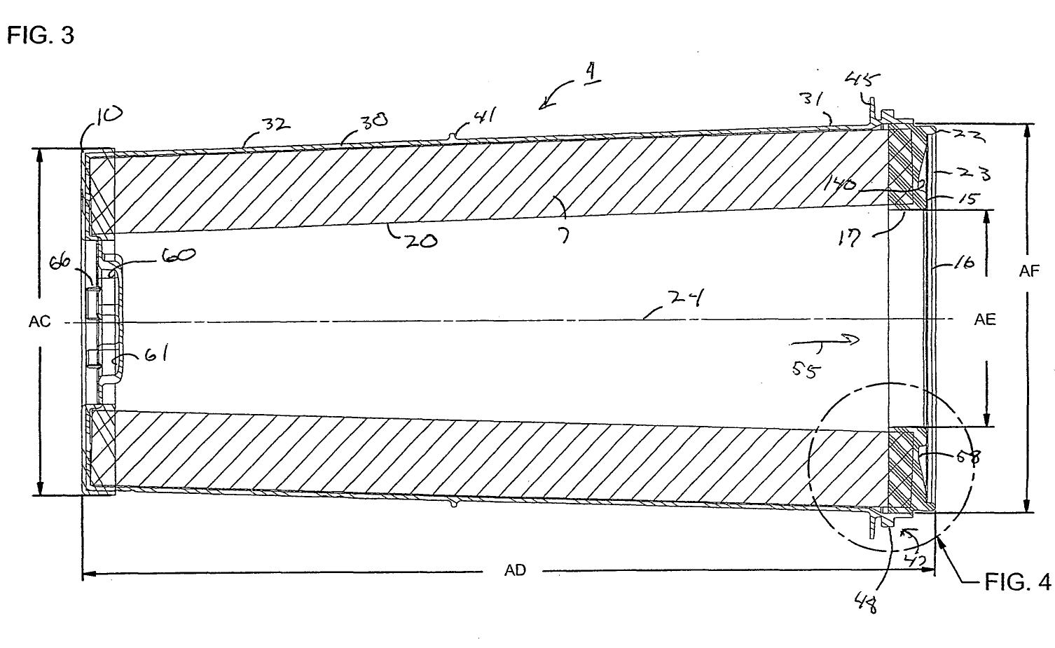

At end 4 the cartridge 1 includes end cap 10. The particular end cap 10 depicted, comprises a closed end cap 11. By “closed” in this context, it is meant that the end cap 10 includes no aperture therethrough, that would allow air flow to bypass the media 7, when passing from an exterior of the cartridge 1 to an interior of the cartridge, as discussed below in connection with FIG. 3.

At opposite end 3, the cartridge 1 includes end cap 15. End cap 15 is an open end cap 16, meaning that it includes, as indicated in FIG. 3, a central aperture 17 therethrough, which allows passage of air, without passage through the media 7, to flow between interior volume 20 defined by the media 7, and a region exterior of the filter cartridge 1. In typical use, aperture 17 would be an outlet aperture positioned in air flow communication with an air inlet duct for an engine or similar arrangement.

Thus, in typical operation air to be filtered passes from an exterior of cartridge 1 into region 20, upon passage through media 7. The media 7 surrounds the interior volume 20, and, thus, air cannot reach the interior volume 20 without passage through the media 7. The filtered air then passes outwardly from the filter cartridge 1 through aperture 17 in end cap 16. This air is then directed through appropriate ducting to an intake of an engine or similar arrangement.

In general, the open end cap 16 is provided with a housing seal arrangement 22 thereon. The housing seal arrangement 22 is generally configured to engage a portion of an air cleaner housing, when filter cartridge 1 is installed for use, sealing the cartridge 1 against the housing, to prevent air from bypassing the media 7. The particular housing seal arrangement 22 depicted, comprises an axial seal member 23 discussed in greater detail below. The term “axial” and variants thereof, as used herein in this context, is meant to refer to a sealing force aligned in a direction along cartridge 1, FIG. 3, in the direction of central axis 24. Thus, an axial seal 23 is a seal that is configured to form a seal under compressive or biasing forces directed in the general direction of extension of axis 24.

In more general terms, the term “axial” when used herein, is meant to refer to a direction of extension generally in the direction of central axis 24. FIG. 3 in contrast, the term “radial” and variants thereof as used herein, is meant to refer to a direction of extension generally perpendicular to central axis 24, i.e., radially around axis 24, FIG. 3.

The filter cartridge 1 includes a variety of additional features, generally described in US Publication US 2004/0134171 published on Jul. 15, 2004 and PCT Publication WO 04/039476 published on May 13, 2004, both of which are incorporated herein by reference.

Referring to FIG. 1, filter cartridge 1 includes exterior or outer support framework or arrangement 30 which surrounds the media 7, and, in the example shown, extends between the opposite end caps 15 and 10. The particular outer support framework 30 shown includes: first, in this instance imperforate, shield region 31; and, second, in this instance perforate, liner region 32. The imperforate shield region 31 generally extends between the end cap 16 and the perforate support region 32. The perforate support region 32 generally extends between the imperforate shield region 31 and closed end cap 10. A typical exterior support arrangement 30 would comprise a single integral structure, for example molded from plastic.

Typically, the imperforate shield region 31 extends a distance of no greater than 40% of an axial length of the filter cartridge 1 between end caps 15 and 10, and typically at least 10% of that distance.

The perforate shield region 32, is typically at least 50% open and usually at least 70% open. By the term “% open” reference is meant that of the amount of perimeter area defined by the perforate support region, at least the stated percent is open to passage of flow therethrough. A typical perforated support region 32 comprises axial ribs 37 interconnected by a cross piece arrangement 38. The cross piece arrangement 38 is shown as a spiral arrangement 39, typically of at least two strands. The perforate shield region 32 typically extends at least 50% of the length of the cartridge 1 between end caps 15 and 10.

Positioned around perforated support region 32 is central radially projecting ring 41. The central ring 41 can be formed as an integral part of the perforated support region 32, and thus of the external support arrangement 30. Ring 41 positioned as a convenient projection for access, during manufacturing.

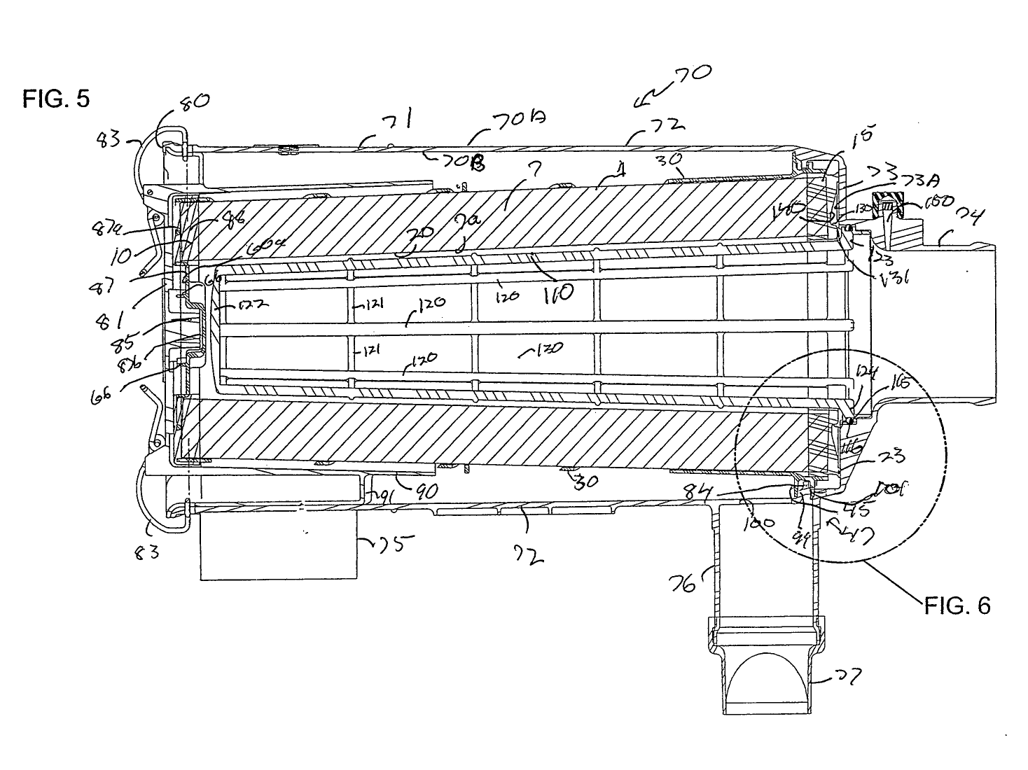

Attention is still directed to FIGS. 1 and 3, and in particular to first, in this instance, imperforate, shield region 31. Imperforate shield region 31 includes, projecting radially outwardly therefrom, dust ring 45. The dust ring 45 generally projects radially outwardly from an adjacent portion of support arrangement 30, i.e., from imperforate shield region 31, a distance of at least 4 mm, and typically 5 mm to 15 mm. The function of the dust ring 45 will be discussed further, below, in connection with the description of FIG. 5.

Positioned adjacent the dust ring 45, cartridge 1 includes a first member 48 of a non-continuously threaded rotational engagement arrangement 47.

Herein the term “non-continuously threaded” is meant to reference the fact that while the engagement mechanism that works through a form of thread arrangement, it is not a continuous thread in rotational extension. The term “rotational engagement arrangement” is meant to refer to the fact that the engagement mechanism operates upon partial rotation of the cartridge 1 in the housing, when installed, to move between: (1) a locked and installed position; and (2) an unlocked and moveable position.

The non-continuously threaded rotational engagement arrangement 47, can be generally as described in US Publication 2004/0134171, published on Jul. 15, 2004 and PCT Publication WO 04/039476, published on May 13, 2004, each of which is incorporated herein by reference. The particular member 48 of the non-continuously threaded rotational engagement arrangement 47 positioned in the example cartridge 1 depicted, comprises a segmented ring of spaced members 49, each of which includes a tip 49a at a first end, a cam surface 50, back or lock surface 51 and a second end with an end stop 52. In use, when the cartridge 1 is installed within a housing, the space members 49 are pushed axially pass retainers or lugs positioned within the housing, and then as the cartridge 1 is rotated, the members 49 are rotated into locking engagement with the projections, lugs or members in the housing (referred to as a second member of the non-continuously threaded rotational engagement mechanism). The rotation is typically such that the housing members first engage the cam surface 50 and then engage with the lock surface 51, rotation being stopped by the end stops 52. As this occurs, within an associated housing, the cartridge 1 is driven axially in the general axial direction of arrow 55, FIGS. 1 and 3, and is locked in position. This will bias and retain the axial seal member 23 against a housing surface, for sealing.

Referring to FIG. 3, open end cap 16 includes therein a groove 58. The groove 58 is positioned in axial overlap with an end of the media 7, and surrounds opening 17. The groove 58 provides, among other things, clearance over a housing feature, during installation. This is discussed below in connection with FIG. 5.

For the particular cartridge 1 depicted, the media 7 is configured in a conical (or tapered) shape, tapering downwardly in outer perimeter size (circumference) in extension from end cap 15 to end cap 10. An angle of taper would typically be at least 1°, often within the range of 2°-4°, inclusive. It is noted, however, that many of the principles described herein can be incorporated in filter cartridges that do not have a tapered (conical) shape to the media, or which have a sharper taper.

To provide exterior media support, and for convenience, the exterior support arrangement 30 also tapers downwardly in outside perimeter of size, as it extends along the media 7, for example from dust ring 45 toward end cap 10.

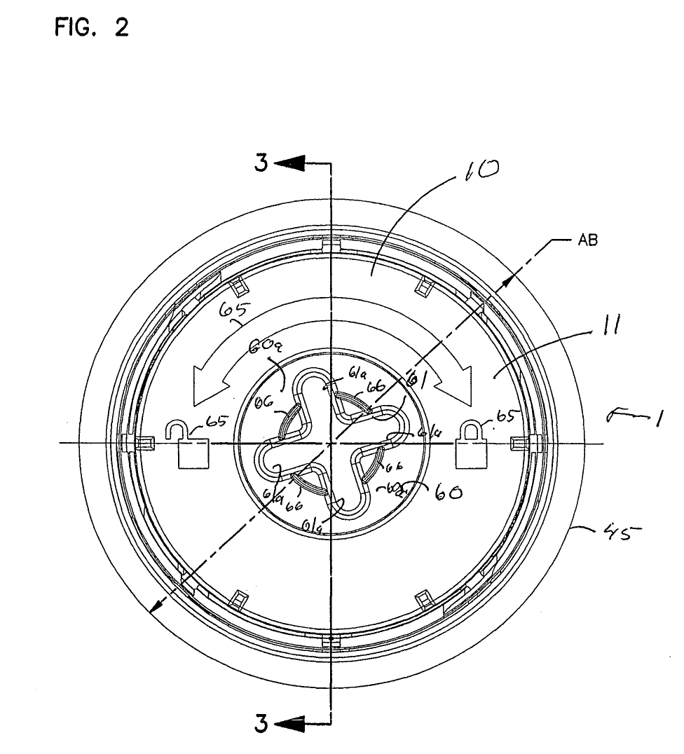

Referring to FIG. 2, closed end cap 11 is depicted as including optional central depression 60, therein, with a non-circular central receiver 61, in this instance configured in a “plus” or “+” shape. This central receiver 61 can be used to receive a non-circular projection on a housing cover for secure installation. This is generally described in US Publication 2004/0134171, published on Jul. 15, 2004 and PCT Publication WO 04/039476, published on May 13, 2004, each of which is incorporated herein by reference. In FIG. 2, the end cap 11 is depicted with indicia 65 thereon, showing proper rotational direction for installation of the cartridge 1 into a locked and sealed position, and removal of the cartridge 1 from the locked position.

Still referring to FIG. 2, it is noted that within central depression 60, between wings 61a of the non-circular central receiver 61, optional projections 66 are positioned. Projections 66 are arcuate, and project outwardly from surface 60a of receiver 60. The projections 66 provide for interference with portion of a housing cover, if installation is not proper. This is discussed below in connection with FIG. 5.

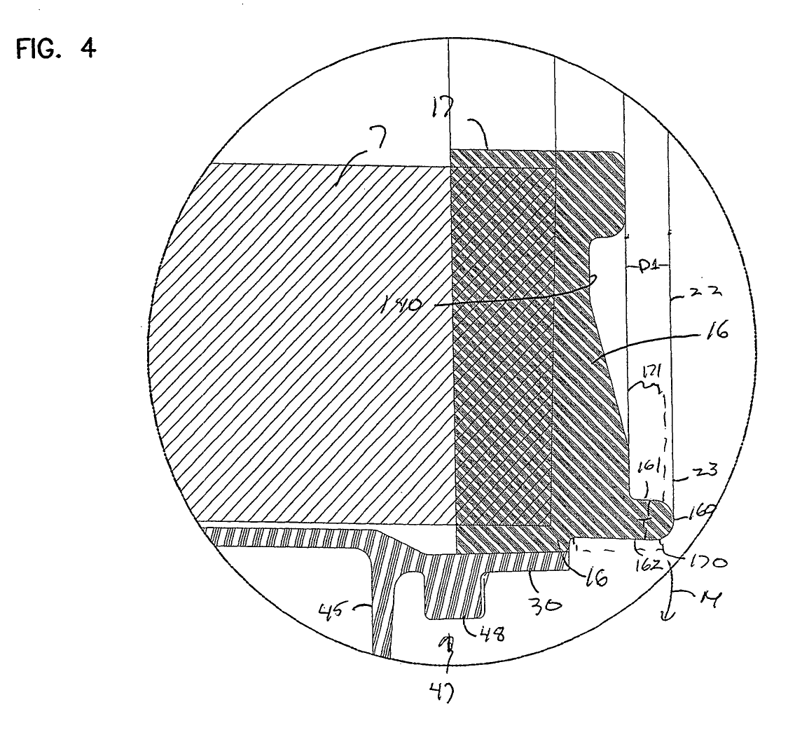

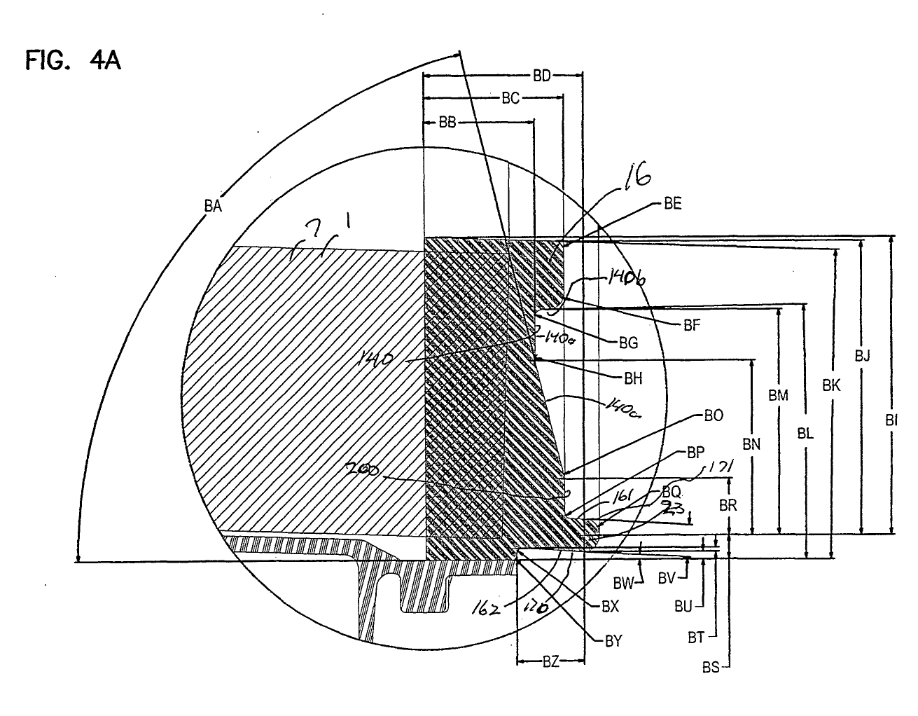

As will be apparent in a review of FIGS. 3 and 4, the axial seal member 23 has a unique advantageous shape and cross-sectional configuration. However, before the unique configuration for the axial seal member 23 is described in detail, general features of an example air cleaner arrangement in which filter cartridge 1 can be positioned for use, are described. With respect to this, attention is directed to FIG. 5.

Referring to FIG. 5, air cleaner 70 is depicted comprising housing 70A including a housing body 71. The housing body 71 includes a side wall 72 and an end wall 73 with air flow outlet 74 therein. The housing further includes an air inlet 75 (in this instance a side inlet) and a dust drop tube 76 with a valve cover 77 thereon. In the example shown, the dust drop tube 76 is positioned at an end of the housing body 71 adjacent the air flow outlet 74; and, the air flow inlet 75 is positioned adjacent an opposite end of the body 71 from the outlet 74. Alternatives are possible, in some applications and principles according to the present invention. However the configuration shown is preferred, for use with cartridges of the type described above, with the features of cartridge 1.

At 73A an inside surface of end wall 73 is positioned, oriented around (i.e., circumscribing) outlet 74. Surface 73A is an end housing seal surface, against which housing seal arrangement 22 discussed above, is pressed, to form an axial housing seal when cartridge 1 is installed within interior 70B of housing 70A. This is discussed in further detail below.

Opposite end wall 73, the housing body 71 includes an open end 80 closed by removable service cover 81. When the service cover 81 is removed, cartridge 1 can be removed from, or be installed in, interior 70B of housing body 71.

Service cover 81 is secured in place by latches 83.

Still referring to FIG. 5, projections 66 are observable. If the cartridge 1 is not properly rotatably positioned in a locked position, it will be difficult to position the cover 81 in position, since a projection 85 on the cover would tend to interfere with projections 66 on cartridge 1.

Many of the features of the housing 70 are generally as described in US Publication 2004/0134171, published on Jul. 15, 2004; PCT Publication WO 04/039476, published on May 13, 2004; and, U.S. Provisional Application 60/699,136, filed Jul. 13, 2005, each of which is incorporated herein by reference. For example, the housing body 71 would include a second member 84 of a non-continuously threaded rotational engagement mechanism 47, for locking engagement with the first member. The second member would typically comprise spaced lugs or projections, as described in U.S. 2004/0134171 and PCT WO 04/039476.

The side inlet 75 may be directed rotationally in any direction, depending on the use. The example side inlet 75 shown is a tangential inlet, meaning air flow into inlet 75 is directed in a rotational pattern around cartridge 1, by being directed tangentially into an inside surface of side wall 71, which has a generally circular cross-section.

The service cover 81 includes central projection 85 therein having a non-circular shape, for receipt within receiver 61, FIG. 2, of cartridge 1. For the particular example shown, projection 85 has a projection arrangement able to engage a “+” shaped receiver. Again, if cartridge 1 is not properly locked in position, projection 85 will engage projections 66, interfering with cover installation.

In general, end cap 10 for the example shown, is a composite end cap including an interior preform structure 87 and molded material 88. The preform structure 87 can be formed integrally with outer support 30. The preform structure 87 would typically be open or perforate in annular region 87a and closed or imperforate in central region 87b. This is described, for example, in US Publication 2004/0134171, published on Jul. 15, 2004 and PCT Publication WO 04/039476, published on May 13, 2004, incorporated herein by reference.

Indexing arrangements or other arrangements can be used to ensure that the service cover 81 is positioned in appropriate rotational position, when it is mounted on housing body 71.

The service cover 81 includes thereon a cyclonic separator arrangement including shield 90 and coiled ramp 91. As the air enters through inlet 75, it is driven into a cyclonic pattern by ramp 91, against shield 90, between shield 90 and side wall 72. This will help separate dust that can be preseparated by dropping through dust drop tube 76 with eventual ejection through valve 77. This, too, is described in US Publication 2004/0134171, published on Jul. 15, 2004 and PCT Publication WO 04/039476, published on May 13, 2004, each of which is incorporated herein by reference.

Referring to FIG. 5, it is noted that the dust flange or shield 45 on the cartridge 1, is positioned, when the cartridge 1 is installed in the air cleaner 70, in alignment with, or adjacent to, a shoulder 99 in the housing next to aperture 100. Aperture 100 provides for air flow communication with dust drop tube 76. In particular, the dust flange or shield 45 is positioned adjacent an edge of aperture 100 located toward outlet 74. As a result, the dust flange or shield 45 inhibits dust, during normal operation, from reaching region 101, in which the non-continuously threaded rotational engagement arrangement 47 is positioned.

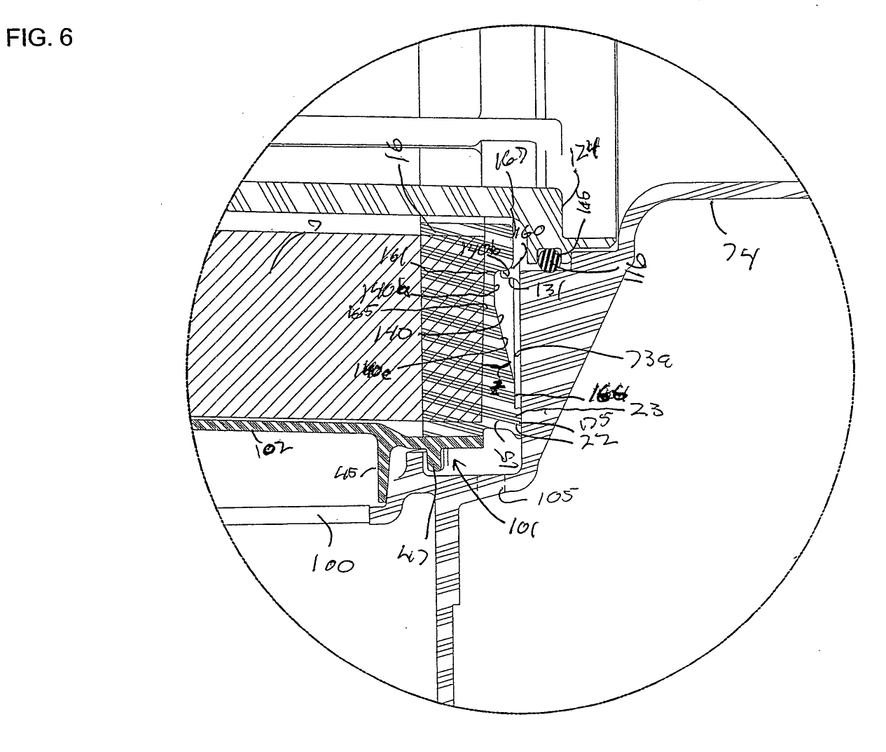

Referring to FIG. 6, at 105, an optional aperture location is depicted, at which an aperture can be provided communication with volume 101 between the non-continuously threaded rotational engagement arrangement 47 and the axial seal 23. As described in U.S. provisional application 60/699, 136 filed Jul. 13, 2005 and incorporated herein by reference, an aperture at such a location can allow for ambient pressure in region 101, which can help inhibit dust flow into region 101, along with dust shield 45. In particular, the pressure in region 102 is typically lower than ambient, due to moving of air through the air cleaner 70. If region 101 is at ambient pressure, as a result of an aperture located at 105, it will be less likely that dust flow into that region will occur.

Referring to FIG. 5, attention is directed to support 110. Support 110 is positioned along an interior 7a of media 7. That is, support 110 is positioned within region 20 defined by the media 7. The support 110 provides for an internal support to the media 7, during operation. The support 110 is separately mounted from the main cartridge 1. The support 110 is shown secured in position at seal 115, to flange 116 in the housing body 71. The seal 115, in the example shown, is an o-ring. The support 110 comprises a plurality of elongate ribs 120, with cross pieces 121 therebetween. At end 122, the support 110 includes a closed end. At end 123, an outer flange 124 is positioned, which includes o-ring 116 mounted thereon. The flange 124 is overlapped by a portion of end cap 15 on the main cartridge 1.

If desired, the support 110 can include a media therein as shown at 130, so that support 110 can also operate as a safety or secondary element. This is described for example in WO 04/039476 and U.S. 2004/0134171, each of which is incorporated herein by reference.

Referring to FIG. 5, at 130, the housing body 71 includes a plurality of axial projections positioned around aperture 131 and extending toward service cover 81. The projections 130 help center support 110, during installation. The end cap 15 includes a groove 140 therein, positioned so that the end cap 15 can clear the spaced projections 130.

Still referring to FIG. 5, and 150, the housing body 71 includes a pressure tap, for mounting of equipment to monitor pressure within the outlet 74, if desired.

Attention is now directed to FIG. 4. In FIG. 4 a cross-section of seal 22 and molded end cap 16 is shown. The seal 22 comprises a rib projecting outwardly from an adjacent portion of end cap 16, in a direction axially outwardly away from the media 7. The rib 22 has a tip 160, and opposite sides 161 and 162. Side 161 will generally be referred to herein as an “inside wall” or as an “inner wall” or by variants thereof. In this context, the term “inner” is meant to refer to the fact that the surface 161 is located radially inwardly of seal 22, i.e., wall 161 faces toward central axis 24, FIG. 3. Surface 162 is generally referred to herein as an “outer wall” or “outside wall”; these terms, in this context being meant to refer to the fact that the wall 162 projects radially outwardly from seal 22 and central axis 24, FIG. 3.

The axial seal ring 23 (seal 22) is positioned to circumscribe or surround aperture 17. The ring 23 is spaced from the aperture 17, by other portions of the end cap.

For the example shown, inner wall 161 includes a relatively straight section (in cross-section) extending over region 171; and, wall 162 includes a relatively straight section (in cross-section) extending over region 170. The axial length (in cross-section) of region 171 is generally at least 1.4 mm, typically 1.5 to 4 mm, usually 1.5-3 mm. The axial length (in cross-section) of region 170 is generally at least 4 mm, and typically 6 to 10 mm, usually 6-8 mm. Thus, side 162 is longer than side 161, and typically has a length at least 1.5 times, sometimes at least 2 times the length of wall 161, when comparing the length of straight region 170 of wall 162, to straight region 171 of wall 161.

Typically, wall 162 is an outer circumferential portion of end cap 16, located in extension beyond preform shell 30.

In general terms, seal 22 (specifically axial seal ring 23), is a type of seal ring referred to herein as a “laterally, outwardly deflectable, flexible axial seal ring”. By this term, and variants thereof, in this context, it is meant that in operation, the seal ring 23, (when pressed and rotated against a housing to form a seal), flexes or bends radially outwardly in the general direction of arrow M, FIG. 4, as sealing occurs. Thus, axial seal ring 23 is a lip or skirt seal that deforms radially outwardly, as it is sealed. This is facilitated by the shape, size and location of the seal ring 22, as well as the method of installation

From the above, it will be understood, then, that the seal ring 23 is configured to flex radially outwardly as a skirt, upon pressure and turning motion as cartridge 1 is installed in the housing, for use. This type of operation is facilitated by certain selected shapes and dimensions, to portions of the axial seal ring 23.

For example, in the example shown in FIG. 4, tip 160 is configured to a circular radius. This provides for a tip that facilitates flexing outwardly as a skirt at the same time being convenient for a molding operation without trapping of air. Tip 160 can be modified to further facilitate flexing outwardly, for example by modification from a semi-circular curve, to a curvature that tends to further drive the tip 160 radially outwardly as it engages a surface during sealing. However the semi-circular radius is convenient both for manufacture and ensuring outward flex.

In addition, if the seal 23 is configured so that an axial distance between base B and tip 160, indicated in FIG. 4 at dimension D1, is less than a radial thickness T, outward flex as a skirt during rotation is facilitated.

Typically the thickness T is at least 1.5 mm, usually at least 2.5 mm and typically 2.5-4.0 mm, although alternatives are possible. Usually the thickness T is not greater than 5 mm, preferably not greater than 4 mm.

Typically, section 170 of surface 162 extends relative to axis 24 at an angle BW FIG. 4A, of either 0°, or it extends outwardly in extension toward tip 160, at an angle BW up to about 6°. Typically it extends outwardly at an angle BW, FIG. 4A, of at least 0.5° and usually within the range of 1°-5°, inclusive, preferably 2.5-4.0. For convenience herein, a 0° angle of extension, will be referred to as angle, for definitional purposes. Outward flare or bend of seal 23, as a skirt, is facilitated if angle BW is greater than 0°, typically 0.5° or greater, usually 2° or greater, typically 2.5°-4°.

The angle BW can be considered to be the angle outward of wall 162 from central axis 24, FIG. 3, or an angle of extension with respect to any other structures within the cartridge 1 that extend along the longitudinal axis 24, without angle therefrom.

Referring to FIG. 4, straight section 171 of wall 161 generally extends at an angle of 0° with respect to the central axis 24, FIG. 3, or at an angle extending radially outwardly in extension toward tip 160, typically at an angle no greater than 6°, usually no greater than 5°. Outward flare or bend of axial seal 23 is facilitated, if the angle of extension of straight section 171 is greater than 0° (outwardly), from a central axis 24, typically at least 0.5°, usually at least 2°, often 2° to 5°, typically 3°-4′. Often section 171 will extend parallel to section 170, although alternatives are possible.

Again, an advantage to axial seal 23 is that it is configured flex or bend laterally outwardly as it is pressed and rotated against wall 73A, FIG. 5, in forming a seal. As a result, region 23 can flex outwardly as a lip, and form an advantageous axial seal. This is shown schematically in FIG. 6, at 175.

An advantage to the seal arrangement 22 of cartridge 1, by comparison to the axial seal arrangement described in U.S. Ser. No. 10/691,856 and PCT U.S./03/33952 incorporated herein by reference, is that the seal arrangement of region 23 can readily deflect or bend outwardly to seal as a skirt with housing wall 73A, which helps make the cartridge 11 relatively easy to install and lock in position, Typical preferred materials for the molded in place end cap 16, and thus the seal 23 are described below. Typically the seal 22 (i.e., axial seal 23) is molded integral with the remainder of end cap 16, when end cap 16 is formed.

In FIGS. 1-3, example dimensions are provided. The dimensions merely indicate a useable example, and alternative applications of principles according to the present disclosure can be made. The example dimensions are as follows: AA=150.1 mm; AB=166 mm; AC=130 mm; AD=331 mm; AE=82.2 mm; and AF=146.6 mm.

In FIG. 4A, selected dimensions are indicated for an example end cap 16. Variations would be made for alternate constructions, however these provide an example of a working arrangement. BA=75.9° (typically in a range between 50° and 80°, depending upon parameters discussed below); BB=11.4 mm; BC=14.4 mm; BD=16.4 mm; BE=1.0 mm radius; BF=1.5 mm radius; BG=0.8 mm radius; BH=0.8 mm radius; BI=29.8 mm; BJ=29.4 mm; BK=1.8°; BL=1°; BM=22.7 mm; BN=17.6 mm; BO=1.5 mm radius; BP=0.5 mm radius; BQ=1.6 mm radius; BR=5.6 mm; BS=2.4 mm; BT=0.4 mm; BU=0.8 mm; BV=3.2 mm; BW=3.1°; BX=0.5 mm radius; BY=0.5 mm radius; BZ=7.0 mm.

Such dimensions can be used to form a convenient end cap 16 with an axial seal ring 23 that will flex outwardly, when the cartridge is installed in a manner discussed previously. Angle BA will generally be selected to extend from a base 140a of groove 140, outwardly to region 200 adjacent ring 23. Region 200 will typically be at least 2 mm wide, usually be 3 to 5 mm wide. The angle BA will be selected, in part based upon the overall diameter of the cartridge 1. The range previously stated will be typical, for many arrangements.

Base 14a will typically be at least 3 mm, typically 4-7 mm, wide, in dimension between regions BG and BH. Inner wall 140b will typically be at least about 2 mm deep, usually 2.5-4 mm deep.

In FIG. 6, slanted in region 140C, in FIG. 4A, is represented at angle Z.

At 166 an outer portion of the end cap 15 is shown, positioned internally of seal region 22 and adjacent thereto. Region 166 is generally parallel to media end 165 and perpendicular to central axis 24. It can be said that groove 140 is surrounded by or circumscribed by, seal ring 23, and is spaced inwardly from seal ring 23 a distance of at least 2 mm, typically a distance within the range of 3 to 5 mm.

The groove shape shown is convenient for extending over projection 131. Also, during molding of end cap 16, a mold feature sized to form a groove 140 in the shape and size shown will be convenient for management of the flow of a rising, curing, resin material such as a polyurethane foam. In particular, a slant in a mold that results in wall 140C will direct resin toward the outer region of the mold, where molding of seal ring 23 is important.

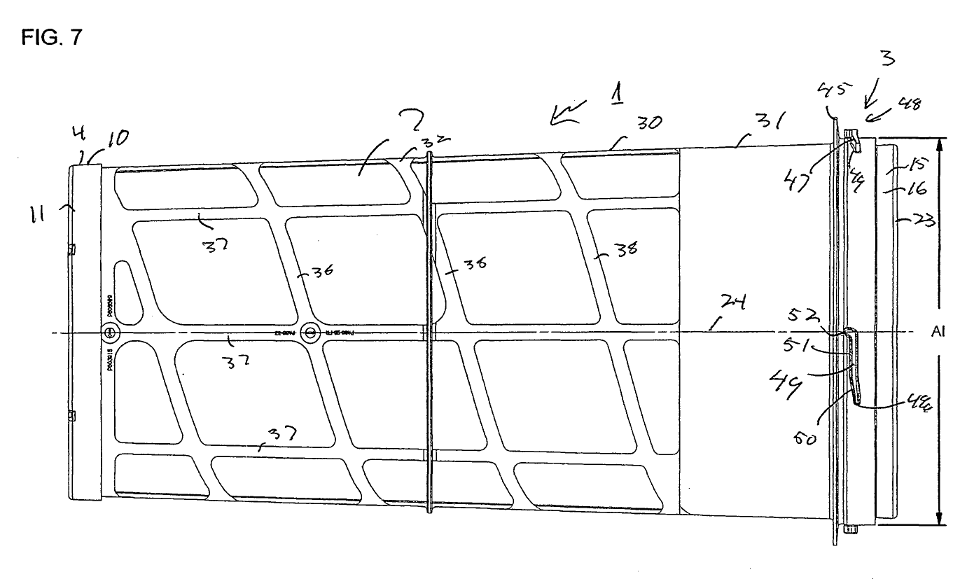

### II. A Second Example, FIG. 7-10A

In FIG. 7-10A, an alternate arrangement is shown. In FIG. 7-10A like features to those previously described, are given the same reference numerals. The primary difference between the arrangement of FIG. 7-10, and the arrangement of FIGS. 1-6, is in groove 280, and end cap 16. Groove 280 is modified from groove 140. The groove 28 is reflective of a smaller diameter end cap.

Formation of such a groove 280 will also clear the projection 131 in the housing, and it relates to an alternate convenient arrangement that can be molded.

In FIGS. 7-9, the dimensions are as follows: AI=150.1 mm; AJ=166 mm; AK=130 mm; AL=331 mm; AM=82.2 mm; and AN=146.6 mm. Of course alternate dimensions can be used for alternate arrangements.

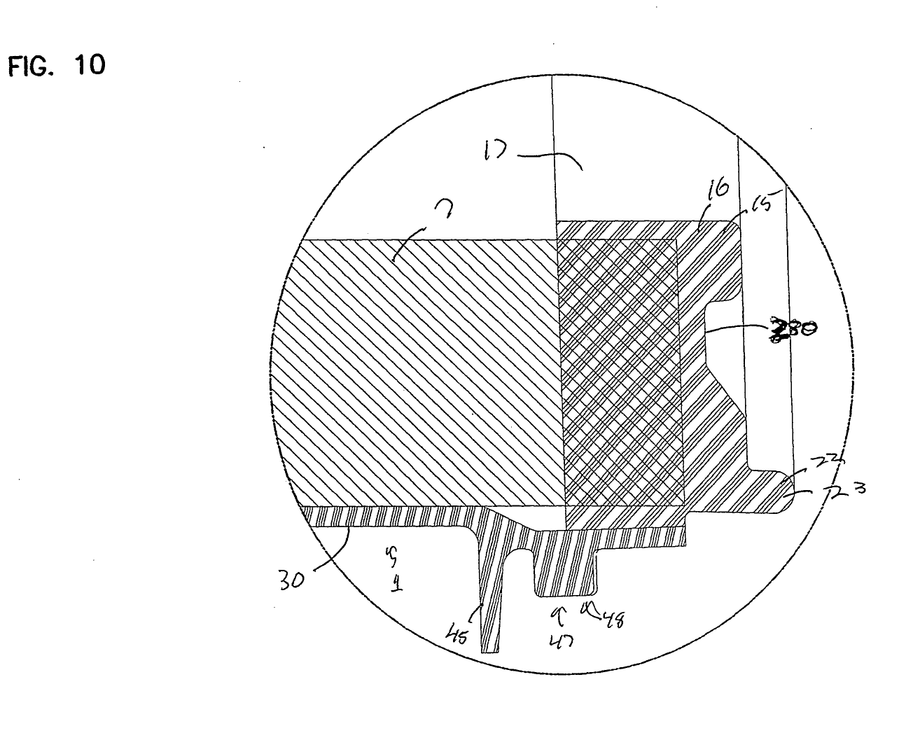

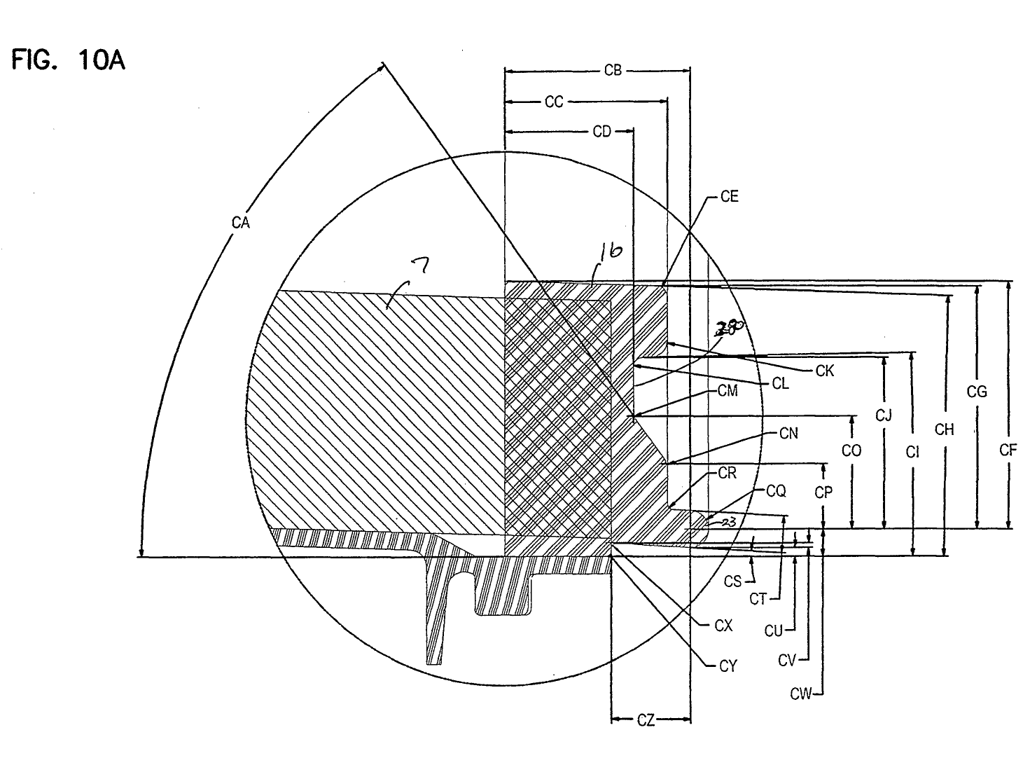

Referring to FIG. 10A, dimensions would be as follows: CA=53.7° (ranging from 50°-80°, depending on the diameter of the element in a typical application); CB=16.4 mm; CC=14.4 mm; CD=11.4 mm; CE=1.0 mm radius; CF=21.2 mm; CG=20.8 mm; CH=1.8°; CI=1°; CJ=14.7 mm; CK=1.5 mm radius; CL=0.8 mm radius; CM=0.8 mm radius; CN=1.5 mm radius; CO=9.7 mm; CP=5.6 mm; CQ=1.6 mm radius; CR=0.5 mm radius; CS (BW in FIG. 4A)=3.1°; CT=3.2 mm; CU=0.8 nm; CV=0.4 mm; CW=2.3 mm; CX=0.5 mm radius; CY=0.5 mm radius; CZ=7.0 mm.

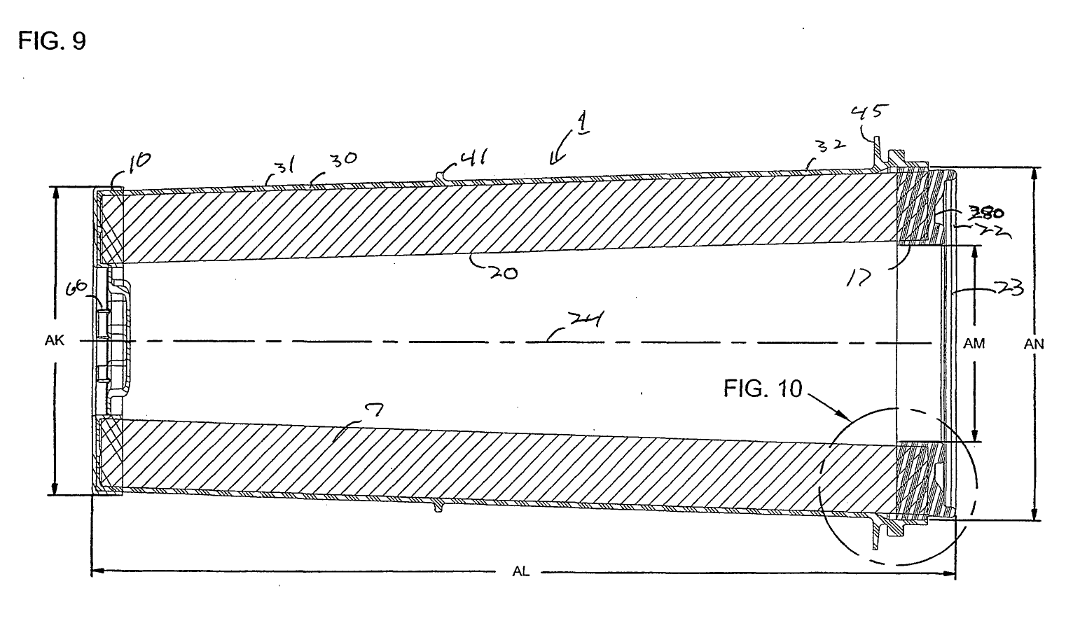

In general, groove 280, FIG. 9, will operate analogously to groove 140, FIG. 3.

### III. Example Materials And Construction

Principles according to the previous descriptions can be implemented in a variety of sizes, shapes and configurations of equipment, and using a variety of materials. However, the principles were developed for application in preferred arrangements and configurations, and with certain preferred materials.

Although alternatives are possible, in general the configurations shown will be particularly advantageous for use as an air cleaner for a vehicle having an air flow demand, at rated operation, the order of about 1,500 cubic feet per minute (cfm) or less, typically about 300 cfm or less; i.e., on the order of 43 cubic meters or less, typically about 9 cubic meters or less. These types of air cleaners are generally found on equipment that uses small gas or small diesel engines.

Preferably with such arrangements, the polyurethane formulation chosen provides for a high foam, very soft, molded end cap.

Preferably the formula chosen will be such as to provide end caps (parts molded from the polyurethane) having an as molded density of no greater than 28 lbs./cubic foot (about 450 kilograms/cubic meter), more preferably no more than 22 lbs./cubic foot (355 kilograms/cubic meter), typically no greater than 18 lbs/cubic foot (290 kilograms/cubic meter) and usually within the range of 12 to 17 lbs/cubic foot (192-275 kilograms/cubic meter). Lower densities can be used, if the material is formulated such that it can be controlled for proper molding and rise.

Herein the term “as molded density” is meant to refer to its normal definition of weight divided by volume. A water displacement test or similar test can be utilized to determine volume of a sample of the molded foam. It is not necessary when applying the volume test, to pursue water absorption into the pores of the porous material, and to displace the air the pores represent. Thus, the water volume displacement test used, to determine sample volume, would be an immediate displacement, without waiting for a long period to displace air within the material pores. Alternately stated, only the volume represented by the outer perimeter of the sample need be used for the as molded density calculation.

In general, compression load deflection is a physical characteristic that indicates firmness, i.e. resistance to compression. In general, it is measured in terms of the amount of pressure required to deflect a given sample of 25% of its thickness. Compression load deflection tests can be conducted in accord with ASTM 3574, incorporated herein by reference. In general, compression load deflection may be evaluated in connection with aged samples. A typical technique is to measure the compression load deflection on samples that have been fully cured for 72 hours at 75° F. or forced cured at 190° F. for 5 hours.

Preferred materials will be ones which when molded, show a compression load deflection, in accord with ASTM 3574, on a sample measured after heat aging at 158° F for seven days, on average, of 14 psi or less, typically within the range of 6-14 psi, and often within the range of 7-10 psi.

Compression set is an evaluation of the extent to which a sample of the material (that is subjected to compression of the defined type and under defined conditions), returns to its previous thickness or height when the compression forces are removed. Conditions for evaluating compression set on urethane materials are also provided in ASTM 3574.

Typical desirable materials will be ones which, upon cure, provide a material that has a compression set of no more than about 18%, and typically about 8-13%, when measured on a sample compressed to 50% of its height and held at that compression at a temperature of 180° F. for 22 hours.

In general, the compression load deflection and compression set characteristics can be measured on sample plugs prepared from the same resin as used to form the end cap, or on sample cut from the end cap. Typically, industrial processing methods will involve regularly making test sample plugs made from the resin material, rather than direct testing on portions cut from molded end caps.

Urethane resin systems useable to provide materials having physical properties within the as molded density, compression set and compression load deflection definition as provided above, can be readily obtained from a variety of polyurethane resin formulators, including such suppliers as BASF Corp., Wyandotte Mich., 48192.

One example usable material includes the following polyurethane, processed to an end product having an “as molded” density of 14-22 pounds per cubic foot (224-353 kilograms/cubic meter). The polyurethane comprises a material made with I36070R resin and I3050U isocyanate, which are sold exclusively to the assignee Donaldson by BASF Corporation, Wyandotte, Mich. 48192.

The materials would typically be mixed in a mix ratio of 100 parts I36070R resin to 45.5 parts I3050U isocyanate (by weight). The specific gravity of the resin is 1.04 (8.7 lbs/gallon) and for the isocyanate it is 1.20 (10 lbs/gallon). The materials are typically mixed with a high dynamic shear mixer. The component temperatures should be 70-95° F. The mold temperatures should be 115-135° F.

The resin material I36070R has the following description:

(a) Average molecular weight
1) Base polyether polyol=500-15,000
2) Diols=0-10,000
3) Triols=500-15,000

(b) Average functionality
1) total system=1.5-3.2

(c) Hydroxyl number
1) total systems=100-300

(d) Catalysts
1) amine=Air Products 0.1-3.0 PPH

(e) Surfactants
1) total system=0.1-2.0 PPH

(f) Water
1) total system=0.2-0.5%

(g) Pigments/dyes
1) total system=1-5% carbon black

(h) Blowing agent
1) water.

The I3050U isocyanate description is as follows:

(a) NCO content—22.4-23.4 wt %

(b) Viscosity, cps at 25° C.=600-800

(c) Density=1.21 g/cm3 at 25° C.

(d) Initial boiling pt.—190° C. at 5 mm Hg

(e) Vapor pressure=0.0002 Hg at 25° C.

(f) Appearance—colorless liquid

(g) Flash point (Densky-Martins closed cup)=200° C.

The material selected for the media may be varied, depending on the anticipated environment of use and availability of various pleatable substrates.

Conventional media available from such suppliers as Hollingsworth and Vose of East Walpole, Mass. can be utilized. It is anticipated that in typical arrangements, pleats on the order of ⅜ inch to 3 inches (0.9 cm to 7.6 cm) in depth, with a pleat population, around the inner diameter, of about 10 to 14 per inch at the larger diameter end (15 to 20 per inch at the smaller diameter end) with a conical unit being used. However, alternate media types and amounts can be used.

The principal structural component of the primary filter cartridge 1, i.e., support 30, will generally be made from a rigid plastic such as a glass filled nylon (for example 33% glass filled nylon 6/6, 1.5 mm. thick). Such a component could generally be made by a plastic molding operation, for example injection molding.

Support structure 110, FIG. 5, which operates as either an inner support for the primary filter cartridge 1 or as both an inner support for the primary filter cartridge 1 and as support for a safety cartridge, will generally be formed from a rigid plastic similar to that used for support 30. Media 130 of a safety filter cartridge is a matter of preference for the particular application, and it would typically be non-pleated media with a side coated with a selected surface modifier, such as a tackifier.

Preferably both the primary filter cartridge and the support (or secondary filter cartridge) are each at least 98%, by weight, metal free, most preferably 100% metal free.

The housing body 71 is preferably molded from plastic material such as a glass filled nylon (for example 33% glass filled nylon 6/6, 2 mm. thick). For such a component an injection molding process could be used. Preferably housing components (except where possibly reinforced by a metal grommet to receive bolts for connection to other components such as a truck frame and/or the latches) are at least 98%, by weight, metal free, preferably 100% metal free.

Cover 87 for the particular preferred embodiment shown, is sized and shaped so that it can be molded from plastic materials. Components of the shield 90 and ramp 91 can be made from glass filled nylon or polypropylene by an injection molding process. They can be molded integral with cover 83 or be premade and then be attached to a remainder of the cover 83, for example by heat staking, with an adhesive or with a snap (mechanical) fit.

The above dimensions, materials and specific described shapes, are meant to be exemplary only, and are not intended to be limiting unless specifically characterized as such in a claim. It will be apparent from the above, however, how the various techniques and improvements described herein can be applied in a wide variety of contexts and specific applications.

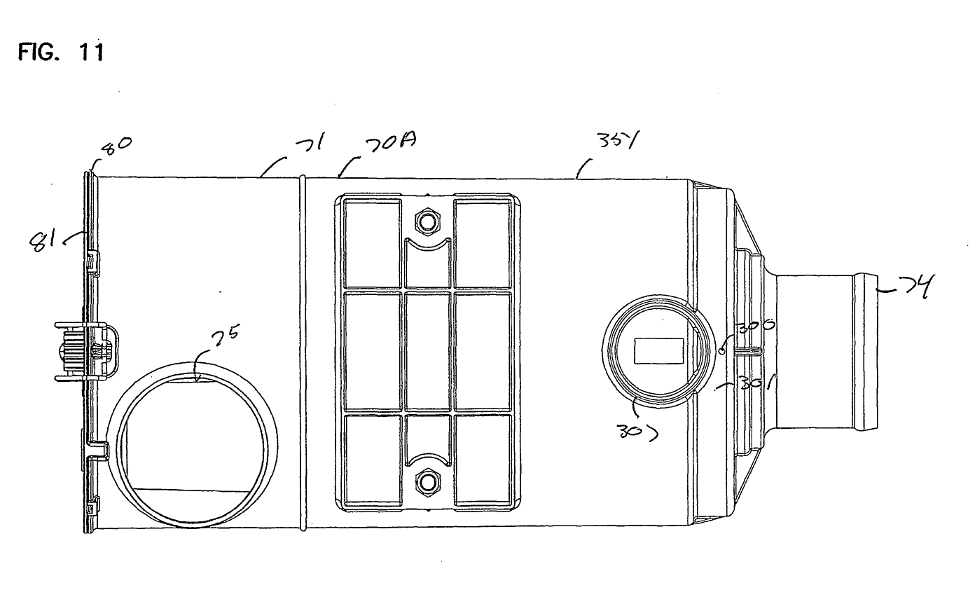

### IV. A Further Example, FIGS. 11-13

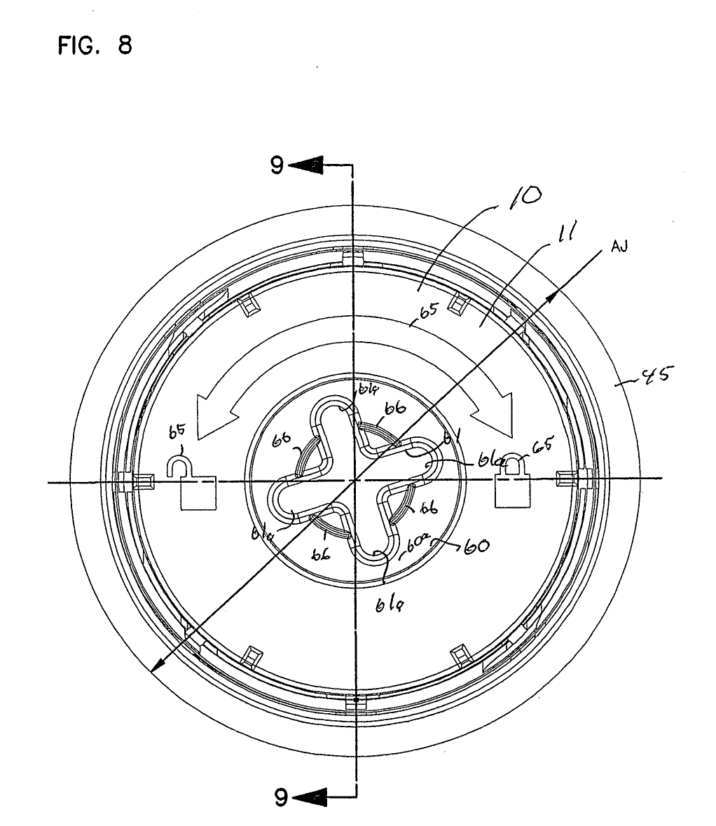

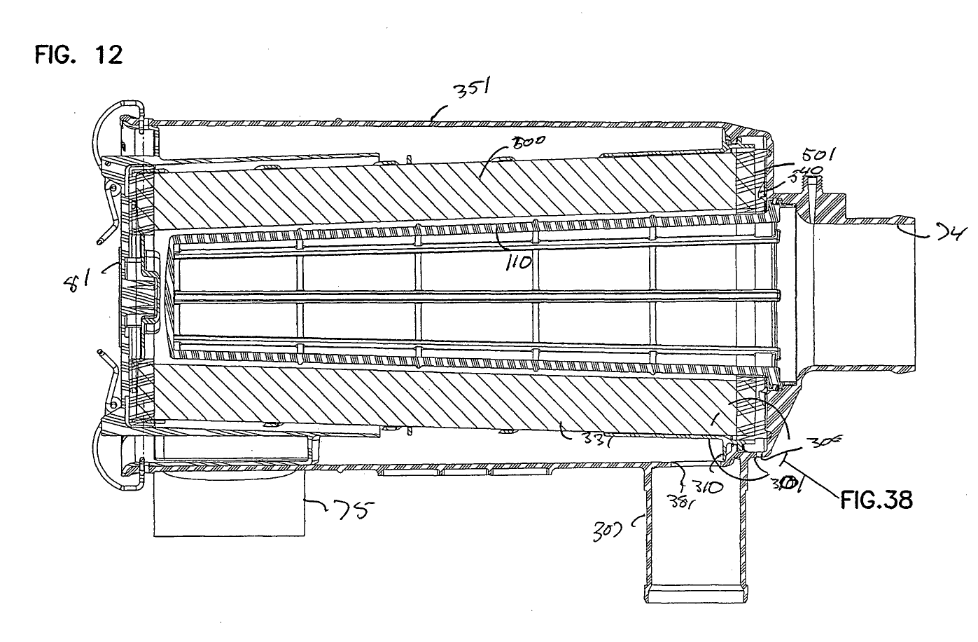

Attention is first directed to FIG. 12. FIG. 12 generally comprises the air cleaner assembly analogous to FIG. 8, including an improvement as described herein. Like reference numerals indicate similar parts. The improvement is an air flow aperture (vent or bleed) arrangement 300 positioned in the housing outer wall 301 at a location between: (i) the dust drop tube and/or the dust shield 310; and, (2) a location on end wall 305 where axial seal gasket 322 will form a housing seal between the cartridge 331 and the housing end wall 305.

The air aperture arrangement 300 will generally provide that a pressure within volume 350 will be approximately ambient. Volume 350 is a volume within air cleaner housing 351, between shield 310 and seal 322. It is the volume in which dust load or dust retention can be a problem, with respect to operation of the non-continuously threaded rotational mounting arrangement 340 to install or dismount the cartridge 1551.

In general, within volume 350 during operation of the air cleaner the pressure will be reduced, relative to ambient, due to such factors as: restriction posed by the pre-cleaner arrangement; and, air movement around and into the media pack 371. As a result of the air aperture arrangement 300, the pressure in region 350 will be closer to ambient. Thus, there will tend to be pressure differential from region 350 to region 370. This will help inhibit dust flow from entering region 2005.

In addition, as a result of the shield 310, any air movement within region 350 will be relatively low, again inhibiting dust movement into the region 350. This is facilitated by shield 310 being positioned to abut, or to being positioned adjacent, housing shoulder 380 between dust drop exit aperture 381 region 350.

In general air aperture arrangement 300 can be a single aperture or plurality of apertures. Typically a single aperture 300 will be sufficient. The location of the aperture 300 can be anywhere in the housing 351 that directly communicates with (i.e., is in direct air flow communication with) region 350. By the term “directly” and variants thereof, in this context, it is meant that the aperture 300 is positioned in housing 351 at a location such that air flow through the aperture 300 goes from an ambient into region 350, without passage through any other region within housing 301.

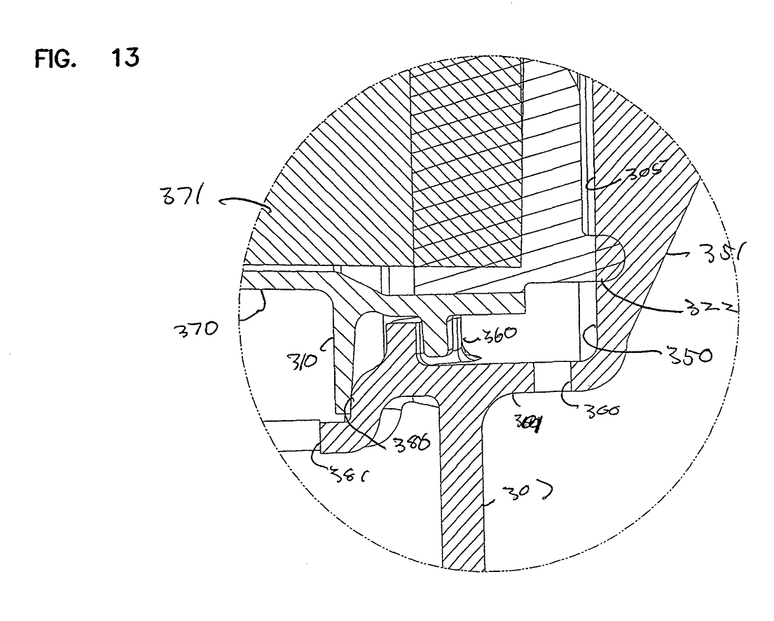

The particular arrangement shown in FIGS. 11-13, the air flow aperture arrangement 300 is a single aperture, located adjacent to, and spaced from, the dust drop tube 307. This is shown in enlarged view, in FIG. 13.

The particular shape of any dust aperture within the dust aperture arrangement, is a matter of choice. It will typically be convenient to use an aperture that is circular in cross-section, but such is not required.

The size of the aperture needs to be sufficient to provide for minimal pressure differential across the housing between the interior 370 and the ambient region 350. Typically a size of at least 0.003 sq. inches (corresponding to a diameter of 1/16 inch) will be sufficient. This will correspond to a size of about 2.0 sq. mm. (i.e., a diameter of 1.59 mm). The largest cross-sectional dimension of the aperture, when a single aperture is used, will typically be at least 1/16 inch (0.0625 inch or 1.59 mm), typically at least ⅛ inch (0.125 inch or 3.18 mm). This dimension would correspond to a diameter, if a circular aperture is used. Typically an aperture larger than about ¼ inch (0.25 inch or 6.35 mm) will not be required, when a single aperture is used. This size would generally correspond to a diameter, if a round aperture is used.

It will typically not be necessary to provide a dust cover over the aperture arrangement, such as a high loft media or similar structure, however in some systems it may be desirable. Especially when the air cleaner is positioned under the hood of a truck, it will typically be preferred not to use any media or screen over aperture arrangement 300.

The improvement described is particularly adapted for utilization in air cleaners which use primary filter cartridge arrangements that have an axial seal on the cartridge, and a dust shield on the cartridge which is positioned adjacent the cartridge end with the axial seal to inhibit dust from entering a mounting arrangement on the cartridge (such as a non-rotationally threaded mounting arrangement) positioned between the dust shield and the axial seal.

In other features, the arrangement of FIGS. 11-13 can be the same as previously described embodiments. It is noted however referring to FIG. 12 and FIG. 13, that the filter cartridge 500 depicted includes many features previously described, but has an open end cap 501 which is slightly modified from the previous discussions in that: seal region 322 has two parallel sides; and, groove 540 is of a somewhat different shape. These differences simply help to indicate how alternatives are possible with principles according to the present disclosure.

It is noted that the arrangement of FIGS. 11-13 is also depicted in U.S. provisional application 60/699,136, filed Jul. 13, 2005, incorporated herein by reference.

1. An air filter cartridge comprising:
(a) first and second, opposite, ends;
(i) the first end having an end cap with an air flow aperture therethrough;
(b) filter media extending between the first and second ends;
(c) an outer framework having a sidewall structure circumscribing the media at least at a location adjacent the first end and having an outer surface;
(i) the cartridge including a first member of a non-continuously threaded, rotational engagement mechanism positioned on an outer surface of the outer framework; and
(d) a laterally, outwardly deflectable, flexible axial seal ring on the first end cap and circumscribing the air flow aperture.

2. An air filter cartridge according to claim 1 wherein:
(a) the axial seal ring has an inside wall, an outside wall and a tip;
(i) the axial seal ring having a thickness, T, of no more than 4 mm in extension between radially overlapping portions of the inside wall and the outside wall.

3. An air filter cartridge according to claim 2 wherein:
(a) the outside wall includes a portion at least 4 mm long that extends at an angle BW relative to a longitudinal central axis of the filter cartridge, of 0° or greater, in extension outwardly from a remainder of the cartridge toward the tip.

4. An air filter cartridge according to claim 3 wherein:
(a) the outside wall includes a portion at least 4 mm long that extends at an outwardly directed angle of 1°-5° relative to the longitudinal central axis.

5. An air filter cartridge according to claim 4 wherein:
(a) the inside wall includes a portion at least 1.4 mm long that extends at an angle 0° or greater, relative to the longitudinal central axis of the filter cartridge, in extension outwardly from a remainder of the first end cap in extension toward the tip.

6. An air filter cartridge according to claim 5 wherein:
(a) angle BW is within the range of 2.5°-4°;
(b) the inside wall includes a portion parallel to the outside wall; and
(c) thickness T is at least 2.5 mm.

7. An air filter cartridge according to claim 1 wherein:
(a) the axial seal ring is positioned at an outside perimeter of the first end cap.

8. An air filter cartridge according to claim 2 wherein:
(a) the outside wall has a straight section at least 1.5 times longer than a straight section of the inside wall.

9. An air filter cartridge according to claim 1 wherein:
(a) the axial seal ring is molded integral with the first end cap.

10. An air filter cartridge according to claim 1 wherein:
(a) the first end cap includes a groove therein positioned:
(i) circumscribed by the axial seal ring; and,
(ii) in overlap with an end of the filter media;
(iii) the groove being at least 2 mm deep from an adjacent outside surface portion of the first end cap.

11. An air filter cartridge according to claim 10 wherein:
(a) the groove is positioned at least 2 mm from the axial seal ring.

12. An air filter cartridge according to claim 11 wherein:
(a) the groove includes an inside wall, an outside wall and a base;
(i) the base being at least 3 mm wide.

13. An air filter cartridge according to claim 12 wherein:
(a) the groove outside wall tapers outwardly, from the base, at an acute angle, of 50° to 80° relative to an end of the media.

14. A filter cartridge according to claim 1 wherein:
(a) the outer framework extends completely between the filter cartridge first and second ends.

15. A filter cartridge according to claim 1 wherein:
(a) the first end cap and seal ring comprise integrally molded foamed polyurethane.

16. A filter cartridge according to claim 1 wherein:
(a) the first member of a rotational engagement mechanism on the outer surface of the outer framework comprises a segmented ring.

17. A filter cartridge according to claim 16 wherein:
(a) each segment, of the segmented ring, has first and second opposite ends with:
(i) the first end of each segment having a tip; and
(ii) the second end of each segment, of the segmented ring, having a stop.

18. A filter cartridge according to claim 1 wherein:
(a) said outer framework extends from said first end to said second end and includes:
(i) an imperforate shield section adjacent said first end and extending over an axial distance of at least 10% of the axial length of the outer framework; and,
(ii) a perforate section having an open area of at least 50% extending between the shield section and the second end; the perforate section having an axial length of at least 50% of the axial length of the outer framework.

19. A filter cartridge according to claim 1 wherein:
(a) the outer framework includes radially outwardly extending dust shield having a radial extension dimension of at least 4 mm.

20. An air filter cartridge according to claim 1 wherein
(a) the media has a conical shaped portion tapering inwardly in extension toward the second end.

21. An air cleaner comprising:
(a) a housing including a housing body and an access cover;
(i) the housing body including an end with an access opening on which the access cover is mounted;
(ii) the housing including an air flow inlet and an air flow outlet; and
(A) the air flow outlet being positioned in an end wall of the housing body opposite the end with the access cover; and,
(B) the end wall having an axial seal surface circumscribing the air flow outlet;
(iii) the housing body including a second member of a non-continuously threaded rotational engagement mechanism therein; and
(b) an air filter cartridge according to claim 1 positioned in the housing with:
(i) the axial seal ring axially sealed against the housing body end wall axial seal surface, with the axial seal ring deflected radially outwardly; and,
(ii) the first member of the non-continuously threaded, rotational engagement mechanism in locking engagement with the second member of the non-continuously threaded rotational engagement mechanism.

22. An air cleaner according to claim 21 wherein:
(a) the filter cartridge is in accord with claim 19; and,
(b) the housing body includes an air aperture therethrough, in communication with a region positioned between the axial seal ring and the radially extending dust shield on the filter cartridge.

23. An air cleaner comprising:
(a) a housing including an air flow inlet, an air flow outlet, a dust drop tube and a main cartridge housing axial seal end surface;
(b) a removable service cover; and,
(c) a serviceable main filter cartridge including:
(i) an extension of media defining an inner volume and extending between first and second, opposite, end caps;
(ii) an axial seal member positioned on the first end cap;
(iii) a housing engagement mechanism projecting outwardly from the filter cartridge; and
(iv) a radially outwardly projecting dust shield surrounding the filter cartridge at a location such that the housing engagement mechanism is positioned between the radially outwardly projecting dust shield and the axial seal member;
(d) the serviceable main filter cartridge being positioned within the housing with:
(i) the axial seal member of the main filter cartridge sealed against the main cartridge housing axial seal end surface;
(ii) the housing engagement mechanism on the main filter cartridge engaged with the housing, to secure the main cartridge in position; and
(iii) the radially outwardly projecting dust shield on the filter cartridge positioned to define a first region between the dust shield and the axial seal member, in which the housing engagement mechanism is positioned; and,
(e) the housing including an air aperture arrangement therethrough positioned at a housing location in direct air flow communication with the first region between the dust shield and the axial seal member.
